(19) United States
(12) Patent Application Publication
(10) Pub. No.: US 2026/0362422 A1
(43) Pub. Date: Nov. 12, 2026

(54) CONTROL CHANNEL SKIPPING DURING OVERLAPPING CONTROL INFORMATION PIGGYBACK DURATIONS

(71) Applicant: QUALCOMM Incorporated, San Diego, CA (US)

(72) Inventors: Morteza SOLTANI, San Diego, CA (US); Jing SUN, San Diego, CA (US); Chih-Hao LIU, San Diego, CA (US); Lior UZIEL, Hod Hasharon (IL)

(21) Appl. No.: 19/202,940

(22) Filed: May 8, 2025

(51) Int. Cl. H04W 72/1273; H04W 72/231; H04W 72/232

(52) U.S. Cl. CPC H04W 72/1273; H04W 72/231; H04W 72/232

(57) ABSTRACT

This disclosure provides methods, components, devices and systems for control channel skipping during overlapping control information piggyback durations. For example, a network entity may transmit, to a user equipment (UE), a message that indicates a control channel skipping configuration that enables the UE to skip control channel monitoring during monitoring occasions which at least partially overlap with time durations in which control information is conveyed via a shared channel that is different from a control channel associated with the monitoring occasions. The UE may receive, via the control channel, information that schedules transmission of the control information via the shared channel during the time durations. The UE may receive the control information via the shared channel during the time durations and may refrain from monitoring the control channel during the monitoring occasions that overlap with the time durations in accordance with the control channel skipping configuration.

### TECHNICAL FIELD

This disclosure relates generally to wireless communication, and more specifically to systems, devices, methods, and techniques associated with control channel skipping during overlapping control information piggyback durations.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a UE is described. The method may include receiving a message that indicates a control channel skipping configuration for the UE, where the control channel skipping configuration enables the UE to skip control channel monitoring during one or more monitoring occasions which at least partially overlap with one or more time durations in which control information is conveyed via a shared channel that is different from a control channel associated with the one or more monitoring occasions, receiving, via the control channel, information that schedules transmission of the control information via the shared channel during the one or more time durations, and receiving, via the shared channel, the control information during the one or more time durations in accordance with the information and the control channel skipping configuration.

A UE for wireless communication is described. The UE may include a processing system that includes processor circuitry and memory circuitry that stores code. The processing system may be configured to cause the UE to receive a message that indicates a control channel skipping configuration for the UE, where the control channel skipping configuration enables the UE to skip control channel monitoring during one or more monitoring occasions which at least partially overlap with one or more time durations in which control information is conveyed via a shared channel that is different from a control channel associated with the one or more monitoring occasions, receive, via the control channel, information that schedules transmission of the control information via the shared channel during the one or more time durations, and receive, via the shared channel, the control information during the one or more time durations in accordance with the information and the control channel skipping configuration.

Another UE for wireless communication is described. The UE may include means for receiving a message that indicates a control channel skipping configuration for the UE, where the control channel skipping configuration enables the UE to skip control channel monitoring during one or more monitoring occasions which at least partially overlap with one or more time durations in which control information is conveyed via a shared channel that is different from a control channel associated with the one or more monitoring occasions, means for receiving, via the control channel, information that schedules transmission of the control information via the shared channel during the one or more time durations, and means for receiving, via the shared channel, the control information during the one or more time durations in accordance with the information and the control channel skipping configuration.

A non-transitory computer-readable medium storing code for wireless communication is described. The code may include instructions executable by one or more processors to receive a message that indicates a control channel skipping configuration for the UE, where the control channel skipping configuration enables the UE to skip control channel monitoring during one or more monitoring occasions which at least partially overlap with one or more time durations in which control information is conveyed via a shared channel that is different from a control channel associated with the one or more monitoring occasions, receive, via the control channel, information that schedules transmission of the control information via the shared channel during the one or more time durations, and receive, via the shared channel, the control information during the one or more time durations in accordance with the information and the control channel skipping configuration.

In some examples of the method, UEs, and non-transitory computer-readable medium described herein, receiving the message may include operations, features, means, or instructions for receiving a radio resource control (RRC) message that indicates the control channel skipping configuration and enables the UE to skip the control channel monitoring during the one or more monitoring occasions which at least partially overlap with the one or more time durations in which the control information may be conveyed via the shared channel.

In some examples of the method, UEs, and non-transitory computer-readable medium described herein, receiving the message and the information may include operations, features, means, or instructions for receiving, via a first monitoring occasion on the control channel, a downlink control information (DCI) message, where the DCI message indicates the control channel skipping configuration and includes the information that schedules the transmission of the control information via the shared channel during the one or more time durations.

Some examples of the method, UEs, and non-transitory computer-readable medium described herein may further include operations, features, means, or instructions for transmitting capability signaling that indicates a capability of the UE to receive the control channel skipping configuration via a scheduling DCI message, where the scheduling DCI message may be received via a first monitoring occasion on the control channel based on the capability signaling, and where the scheduling DCI message indicates the control channel skipping configuration and includes the information that schedules the transmission of the control information via the shared channel during the one or more time durations based on the capability signaling.

In some examples of the method, UEs, and non-transitory computer-readable medium described herein, receiving the control information may include operations, features, means, or instructions for receiving, via the shared channel, a set of multiple instances of the control information during the one or more time durations, where a first instance of the set of multiple instances may be received during a first time duration and indicates a duration over which the UE may be to skip the control channel monitoring in accordance with the control channel skipping configuration.

In some examples of the method, UEs, and non-transitory computer-readable medium described herein, receiving the control information may include operations, features, means, or instructions for receiving, via the shared channel, a set of multiple instances of the control information during the one or more time durations, where each instance of the set of multiple instances may be received during a respective time duration and includes a conditional skip indication that indicates whether the UE may be to continue to skip the control channel monitoring during a next monitoring occasion that may be after the respective time duration during.

Some examples of the method, UEs, and non-transitory computer-readable medium described herein may further include operations, features, means, or instructions for refraining, in accordance with the control channel skipping configuration, from monitoring the control channel during the one or more monitoring occasions.

Some examples of the method, UEs, and non-transitory computer-readable medium described herein may further include operations, features, means, or instructions for monitoring the control channel during one or more second monitoring occasions in accordance with a duration of the control channel skipping configuration expiring before the one or more second monitoring occasions.

### BRIEF DESCRIPTION OF THE DRAWINGS

FIG. 1 shows an example of a wireless communication system.

FIG. 2 shows an example of a signaling configuration that supports control channel skipping during overlapping control information piggyback durations.

FIG. 3 shows an example of a communication timeline that supports control channel skipping during overlapping control information piggyback durations.

FIG. 4 shows an example of a communication timeline that supports control channel skipping during overlapping control information piggyback durations.

FIG. 5 shows an example of a process flow that supports control channel skipping during overlapping control information piggyback durations.

FIG. 6 shows a block diagram of a processing system that supports control channel skipping during overlapping control information piggyback durations.

FIG. 7 shows a diagram of a system including a device that supports control channel skipping during overlapping control information piggyback durations.

FIGS. 8 through 10 show flowcharts illustrating methods that support control channel skipping during overlapping control information piggyback durations.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a network entity may convey downlink control information (DCI) to a user equipment (UE) via a control channel, where the DCI may convey control information and scheduling information for the UE. Additionally, or alternatively, the network entity may support DCI piggybacking on a shared channel, in which the network entity may transmit the DCI via a shared channel instead of via the control channel. That is, the network entity may “piggyback” the DCI on the shared channel (e.g., the DCI may be appended to or otherwise interleaved in time and/or frequency with other shared channel transmissions). DCI piggybacking on a shared channel may reduce processing by a UE that is to receive the DCI, and may improve efficiency.

In some examples, a UE may support control channel skipping, where the UE does not monitor a control channel in one or more monitoring occasions to reduce power consumption. The network entity may transmit a control channel skip order that triggers the UE to stop monitoring the control channel for a duration. However, if additional control channel skipping is desired beyond the duration indicated via the skip order, the network entity may transmit repeated orders until skipping is no longer desired, which may increase overhead and reduce throughput. In some cases, a DCI that is conveyed via a shared channel may represent an example of an additional control resource that is allocated to the UE and that may relieve congestion and overhead of control resources in the control channel. Accordingly, techniques for leveraging such resources instead of the control channel and combining control channel skipping and piggybacked DCI, such that the piggybacked DCI overlap in time with the control channel skipping, may be beneficial.

Aspects of the subject matter described in this disclosure relate to signaling and configurations for aligning durations in which DCI is piggybacked on a shared channel with durations in which a UE skips monitoring a control channel. For example, a network entity to transmit, to the UE, signaling including a control channel skipping configuration that enables the UE to skip control channel monitoring in monitoring occasions on the control channel that overlap with time durations in which DCI is piggybacked on a shared channel. The control signaling may be a radio resource control (RRC) configuration that indicates the control channel skipping configuration. In such cases, the network entity may subsequently transmit a scheduling DCI via the control channel, and the scheduling DCI may indicate one or more time durations during which the UE is to monitor for DCI on the shared channel. The UE may skip monitoring the control channel during the one or more time durations according to the control channel skipping configuration enabled via RRC and the time durations indicated via the scheduling DCI. Additionally, or alternatively, the control signaling may be a scheduling DCI on the control channel that indicates the control channel skipping configuration and that schedules the subsequent piggybacked DCIs via the shared channel. The UE may thereby refrain from monitoring one or more monitoring occasions on a control channel if the UE is scheduled to receive DCI via a shared channel in time durations that overlap in time with the one or more monitoring occasions.

Particular aspects of the subject matter described in this disclosure can be implemented to realize one or more of the following potential advantages. In some examples, by coordinating control channel skipping with DCI piggybacking, the described techniques can be used to reduce overhead, processing and power consumption while maintaining or improving communication reliability and performance as compared with systems in which the devices do not coordinate control channel skipping with DCI piggybacking. For example, by indicating, to a UE, to skip monitoring a control channel when DCI piggybacking is occurring on a shared channel, the network entity may ensure that the UE refrains from excess monitoring in control channel monitoring occasions in which the network entity will not be transmitting information to the UE, which may improve coordination between the devices and reduce power consumption at the UE.

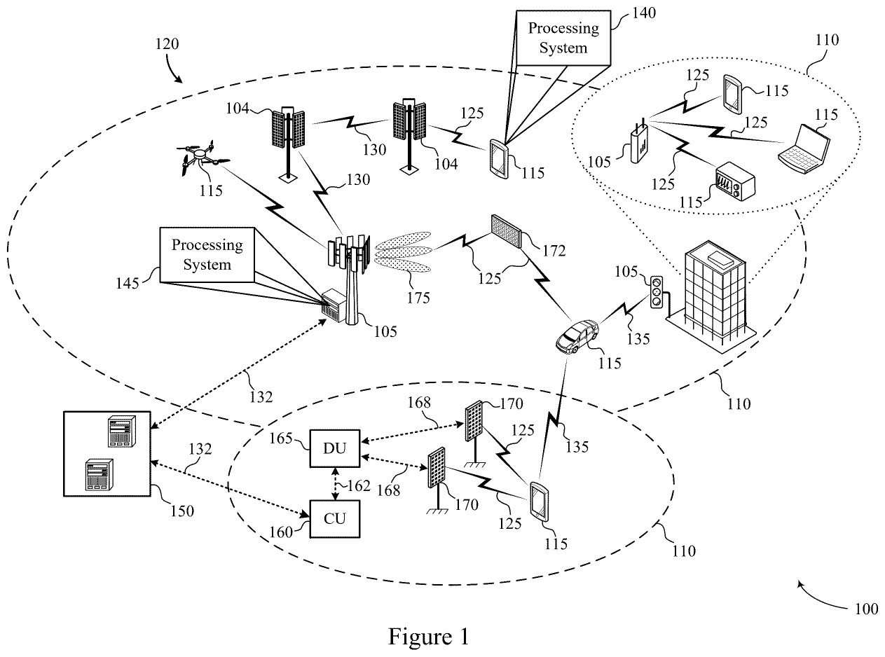

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating DCI and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

In some systems, DCI may be used to convey various types of information, such as a downlink grant, an uplink grant, other types of information, or any combination thereof. DCI may be transferred over a control region (e.g., delivered in the CORESET) of a downlink control channel, such as a PDCCH. A UE 115 may blind decode multiple decoding candidates in the CORESET to identify the DCI targeting the UE 115. The blind decoding candidates may be organized into search space sets and one or more search space sets may be associated with one CORESET. In some examples, the blind decoding design may be optimized for scenarios in which there are multiple UEs 115 to be served with the PDCCH at the same time. For example, the blind decoding design may be configured to reduce blocking between UEs 115 by randomly hashing locations of PDCCH from different UEs 115 differently in the CORESET. Additionally, or alternatively, analogy beamforming and resource allocation may be supported via some PDCCHs to improve service of multiple UEs 115. Blind decoding may generally increase processing and complexity by a UE 115.

In some examples, a network entity 105 may transmit DCI via a shared channel, such as a PDSCH. Transmitting DCI via the shared channel may be referred to as DCI piggybacking herein. A network entity 105 may support unicast DCI piggyback, broadcast DCI piggyback, multicast DCI piggyback, or any combination thereof. For unicast DCI piggyback, other DCIs (other than a DCI conveyed via a PDCCH) for a UE 115 may be conveyed via (e.g., piggybacked in) a PDSCH for the UE 115. The unicast DCI piggyback may support use cases with relatively bursty traffic by, for example, supporting transmission of multiple DCIs to a same UE 115 at the same time (e.g., via the PDCCH and the PDSCH). For example, a unicast standalone DCI conveyed via a CORESET may indicate resources for a PDSCH and may also point to resources within the PDSCH via which one or more piggyback DCIs may be conveyed to the UE 115. For broadcast/multicast DCI piggyback, the network entity 105 may collect DCIs for multiple UEs 115 together for transmission within a PDSCH. In some examples, the network entity 105 may group some of the UEs 115 that may receive a same PDSCH (e.g., UEs 115 with similar MCS, similar beams, and the like). Multicast/broadcast DCI piggyback may support reliable communications for network entities 105 with relatively smaller antennas (e.g., that support relatively few beams), or may support reliable communications for a relatively large quantity of users (e.g., due to ease of forming groups), or both. In some examples, the multicast/broadcast DCI piggyback may target control offloading from a PDCCH region to a PDSCH region.

By conveying DCI via a shared channel, the network entity 105 may offload control information from a control channel region, which may reduce blind decoding by receiving UE(s) 115. That is, a receiving UE 115 may not perform as much blind decoding to receive and decode a DCI via a PDSCH as compared with the blind decoding needed for the UE 115 to receive and decode a DCI via a CORESET in a PDCCH, which may reduce processing, power consumption, and UE complexity, among other examples. Additionally, or alternatively, DCI piggybacking may increase efficiency for control information delivery. For example, DCI piggybacking on a shared channel may reduce cyclic redundancy check (CRC) for aggregated use cases, and may reduce CRC length due to less pruning, which may reduce overhead. In some examples, DCI piggybacking on a shared channel may increase a coding gain with larger codeword size and aggregated DCIs, may support DMRS sharing with data DMRS, may improve beamforming accuracy and modulation order/rank efficiency (e.g., by reusing data rate control for control with a backoff for higher reliability as compared to data due to lack of retransmission for control), may increase frequency diversity (e.g., by sharing data frequency domain interleaving and precoder cycling), or any combination thereof.

Devices in the wireless communication system 100 may support PDCCH skipping, in some examples. PDCCH skipping may enhance power saving by UEs 115. A network entity 105 may transmit a DCI to one or more UEs 115 to indicate a time duration that the one or more UEs 115 should skip PDCCH monitoring. The UEs 115 may refrain from monitoring a PDCCH for the indicated duration, which may reduce power consumption and processing by the UEs 115. The network entity 105 may configure some quantity of one or more PDCCH skip durations (e.g., up to three PDCCH skip durations). The network entity 105 may transmit RRC messages that indicate the configured PDCCH skip durations. The network entity may monitor a buffer occupancy and determine when to initiate PDCCH skipping. The skip duration may be fixed or variable based on whether the network entity 105 knows the traffic pattern. The network entity 105 may transmit a DCI including a PDCCH monitoring adaptation field, which may be referred to as a PDCCH skip order herein. The PDCCH monitoring adaptation field may include a one or two-bit structure associated with a set of DCI formats. The UE 115 may receive the PDCCH skip order via a DCI. The UE 115 may stop monitoring the PCCH for the indicated quantity of slots after receiving the DCI containing the PDCCH skip order.

In some examples, the network entity 105 may transmit a new DCI (e.g., a dummy DCI) containing another PDCCH skip indication once a current PDCCH skip duration expires, if the network entity 105 does not have data available (e.g., to maximize power saving by the UE 115 when no data is available). However, in some examples, the network entity 105 may not have sufficient PDCCH capacity to continuously transmit dummy DCIs to multiple UEs 115 simultaneously. As such, some UEs 115 may experience a loss of power saving efficiency by, for example, monitoring PDCCH when the network entity 105 does not have control information to transmit. Accordingly, techniques for improving PDCCH skipping efficiency may be beneficial.

As described herein, a network entity 105 and a UE 115 within the wireless communication system 100 may exchange signaling and configurations for aligning durations in which DCI is piggybacked on a shared channel with durations in which the UE 115 skips monitoring a control channel. For example, the network entity 105 may transmit, to the UE 115, signaling including a control channel skipping configuration that enables the UE 115 to skip control channel monitoring in monitoring occasions on the control channel that overlap with time durations in which DCI is piggybacked on a shared channel. The control signaling may be a RRC configuration that indicates the control channel skipping configuration. In such cases, the network entity 105 may subsequently transmit a scheduling DCI via the control channel, and the scheduling DCI may indicate one or more time durations during which the UE 115 is to monitor for DCI on the shared channel. The UE 115 may skip monitoring the control channel during the one or more time durations according to the control channel skipping configuration enabled via RRC and the time durations indicated via the scheduling DCI. Additionally, or alternatively, the control signaling may be a scheduling DCI on the control channel that indicates the control channel skipping configuration and that schedules the subsequent piggybacked DCIs via the shared channel. The UE 115 may thereby refrain from monitoring one or more monitoring occasions on a control channel if the UE 115 is scheduled to receive DCI via a shared channel in time durations that overlap in time with the one or more monitoring occasions.

Devices of the wireless communication system 100 may be configured to support one or more aspects of the described techniques for control channel skipping during overlapping control information piggyback durations. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support reduced overhead, processing and power consumption while maintaining or improving communication reliability and performance as compared with systems in which the devices do not coordinate control channel skipping with DCI piggybacking. For example, by indicating, to a UE 115, to skip monitoring a control channel when DCI piggybacking is occurring on a shared channel, a network entity 105 may ensure that the UE 115 refrains from excess monitoring in control channel monitoring occasions in which the network entity 105 will not be transmitting information to the UE 115 without increasing overhead, which may improve coordination between the devices and reduce power consumption at the UE 115.

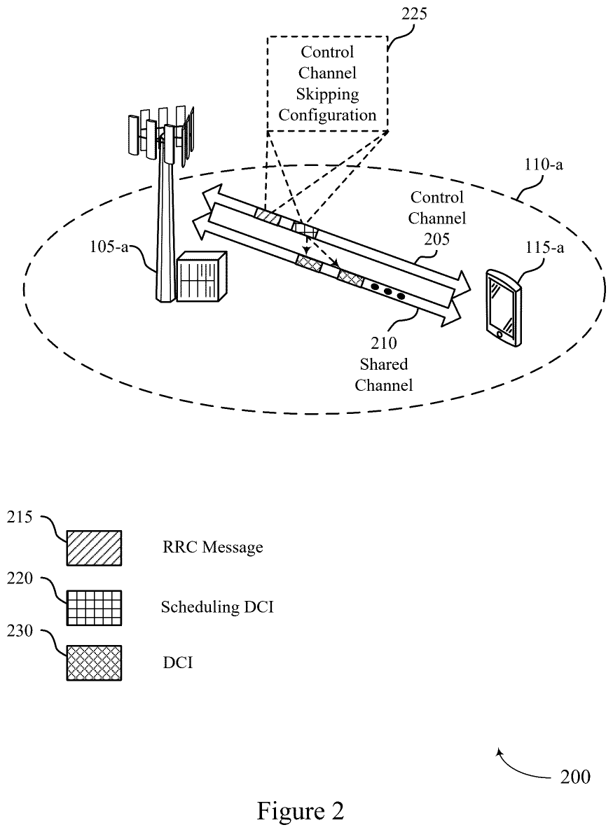

FIG. 2 shows an example of a signaling configuration 200 that supports control channel skipping during overlapping control information piggyback durations. The signaling configuration 200 may implement or be implemented by aspects of the wireless communication system 100, as described with reference to FIG. 1. For example, the signaling configuration 200 illustrates a UE 115-a and a network entity 105-a, which may represent examples of the UEs 115 and the network entities 105 described with reference to FIG. 1. The network entity 105-a and the UE 115-a may communicate within a geographic coverage area 110-a and via one or more communication links (e.g., Uu links), which may include a control channel 205, a shared channel 210, one or more other channels, or any combination thereof. In this example, the network entity 105-a may enable the UE 115-a to perform control channel skipping during durations in which the UE 115-a is to receive DCI piggybacked on a shared channel.

The network entity 105-a may support DCI piggybacking, in which the network entity 105-a may transmit DCI 230 via the shared channel 210 (e.g., a PDSCH) instead of or in addition to the control channel 205 (e.g., a PDCCH). When the network entity 105-a transmits DCI 230 via the shared channel 210 (e.g., when there is DCI piggyback assigned to the UE 115-a in PDSCH), the DCI 230 may occupy or otherwise represent a dedicated control resource allocated to the UE 115-a (e.g., for communications with the UE 115-a). The network entity 105-a may benefit from prioritizing the usage of this control resource in the shared channel 210 over other control resources in the control channel 205 by, for example, improving resource allocation and throughput with reduced decoding complexity at the UE 115-a.

As described herein, if the network entity 105-a transmits the DCI 230 via the shared channel 210 to leverage use of the dedicated control resource(s), the UE 115-a may skip monitoring of the control channel 205 in slots (e.g., transmission time intervals (TTIs), durations) in which the DCI 230 is conveyed via the shared channel 210 for power saving. The UE 115-a may resume monitoring of the control channel 205 when a daisy chain of one or more piggybacked DCIs 230 on the shared channel 210 terminates. The network entity 105-a may transmit a scheduling DCI 220 to the UE 115-a via the control channel 205 (e.g., via a CORESET), where the scheduling DCI 220 may schedule one or more data transmission via the shared channel 210 and may schedule transmission of the DCI 230 via the shared channel 210 during one or more time durations. According to the described techniques, when the UE 115-a receives the scheduling DCI 220 indicating the DCI piggyback on the shared channel 210 (e.g., PDSCH), the UE 115-a may skip monitoring the control channel 205 (e.g., CORESETS on the PDCCH) during monitoring occasions that overlap with the DCI 230 piggybacked on the shared channel 210.

The network entity 105-a may transmit, to the UE 115-a via the control channel 205 (or some other communication link or channel), a message that indicates a control channel skipping configuration 225. The control channel skipping configuration 225 may be referred to as a PDCCH skip order in some examples herein, and may enable the UE 115-a to skip control channel monitoring during one or more monitoring occasions on the control channel 205 which at least partially overlap with one or more time durations in which control information (e.g., the DCI 230) is conveyed via the shared channel 210. That is, the control channel skipping configuration 225 may enable the described PDDCH skipping during overlapping piggyback DCI durations.

The message may, in some examples, be an RRC message 215. For example, the network entity 105-a may transmit the RRC message 215 to the UE 115-a to indicate one or more communication parameters for communications between the UE 115-a and the network entity 105-a, as well as the control channel skipping configuration 225. The network entity 105-a may accordingly indicate a PDCCH skip order (e.g., the control channel skipping configuration 225) via an RRC message 215 (e.g., semi-static indication of PDCCH skipping when a PDCCH overlaps with DCI piggyback on PDSCH). In such examples, the network entity 105-a may subsequently transmit a scheduling DCI 220 via the control channel 205 that schedules one or more data transmission via the shared channel 210 and that schedules transmission of the DCI 230 via the shared channel during one or more time durations. The UE 115-a may receive the scheduling DCI 220 and may monitor the shared channel 210 for the DCI 230 during the one or more time durations accordingly. The UE 115-a may additionally refrain from monitoring one or more monitoring occasions on the control channel 205 that overlap with the time durations in which the DCI 230 is piggybacked on the shared channel 210. The UE 115-a may perform the control channel skipping in accordance with the control channel skipping being enabled via the RRC message 215. In some examples, the network entity 105-a may transmit a second RRC message 215 at a second time that is after the one or more time durations in which the DCI 230 is conveyed via the shared channel 210, where the second RRC message 215 may indicate an end to the control channel skipping configuration 225. A first RRC message 215 may signal a skip order, and a later RRC message 215 may signal a stoppage of the skip order. That is, the network entity 105-a may enable or disable a PDCCH skip order via an RRC message 215.

Additionally, or alternatively, the message that conveys the control channel skipping configuration 225 may be the scheduling DCI 220. For example, the network entity 105-a may indicate the control channel skipping configuration (e.g., PDCCH skip order) when control channel monitoring occasions overlap with the DCI 230 piggybacked on the shared channel 210 via the scheduling DCI 220 conveyed via the control channel 205 that indicates the DCI 230 is piggybacked on the shared channel 210 (e.g., dynamic indication of PDCCH skipping when PDCCH overlaps with DCI piggyback on PDSCH). In this example, the network entity 105-a may transmit the RRC message 215 to enable or disable the PDCCH skip order. A structure of one or more bits may be defined within the scheduling DCI 220, the RRC message 215, or both, to convey the control channel skipping configuration 225 as described herein.

The UE 115-a may receive the control channel skipping configuration 225 via the RRC message 215, the scheduling DCI 220, or both. The UE 115-a may additionally receive, via the control channel 205, information that schedules transmission of the DCI 230 via the shared channel 210. The information may be conveyed via the scheduling DCI 220 on the control channel 205, for example. The UE 115-a may accordingly monitor the shared channel 210 and receive the one or more piggybacked DCI 230 on the shared channel 210. The one or more piggybacked DCI 230 may be received during one or more time durations (e.g., TTIs, slots, occasions). The UE 115-a may refrain from monitoring the control channel 205 during the one or more time durations in which the piggybacked DCI 230 are received. The UE 115-a may perform the control channel skipping in accordance with the control channel skipping configuration 225.

The described techniques may thereby enable the UE 115-a to refrain from monitoring the control channel 205 may control information is being conveyed via the shared channel 210, which may reduce blind decoding performed by the UE 115-a, thereby reducing processing, power consumption, and complexity, among other examples. The network entity 105-a may dynamically or semi-statically enable or disable the control channel skipping by the UE 115-a, which may provide for the network entity 105-a to align periods in which the network entity 105-a does not have control information to transmit via the control channel 205 with the control channel skipping by the UE 115-a, thereby improving coordination and throughput.

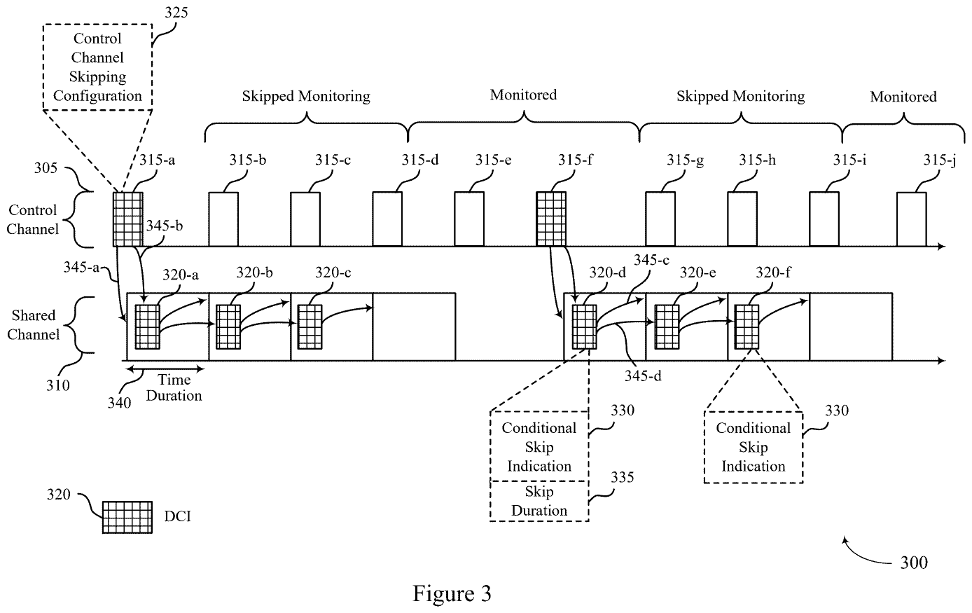

FIG. 3 shows an example of a communication timeline 300 that supports control channel skipping during overlapping control information piggyback durations. The communication timeline 300 may implement or be implemented by aspects of the wireless communication system 100 and the signaling configuration 200, as described with reference to FIGS. 1 and 2. For example, the communication timeline 300 illustrates a timeline for communications between a UE 115 and a network entity, which may represent examples of corresponding devices as described with reference to FIGS. 1 and 2. The UE 115 and the network entity 105 may communicate via a control channel 305 and a shared channel 310, which may represent examples of the control channel 205 and the shared channel 210, respectively, as described with reference to FIG. 2. As described herein, the network entity 105 may transmit one or more messages or other indications to the UE 115 to enable the UE 115 to skip monitoring the control channel 305 during one or more monitoring occasions 315 that at least partially overlap in time with one or more time durations 340 during which the UE 115 receives DCI 320 via the shared channel 310.

The control channel 305 may be a PDCCH or other type of control channel that includes multiple monitoring occasions 315 (e.g., monitoring occasions 315-a, 315-b, 315-c, 315-d, 315-e, 315-f, 315-g, 315-h, 315-i, and 315-j). A monitoring occasion 315 may include one or more time and frequency resources within the control channel 305 that are allocated for potential control signaling targeting the UE 115. The UE 115 may receive control signaling that indicates the monitoring occasions 315 and/or a periodicity of the monitoring occasions 315, and the UE 115 may monitor the control channel using blind decoding techniques during the monitoring occasions 315.

The shared channel 310 may be a PDSCH or other type of shared channel that includes one or more time durations 340. Communications via the shared channel 310 may be scheduled via a scheduling DCI conveyed via the control channel 305, via piggybacked DCI 320 conveyed via the shared channel 310, or both. Accordingly, the UE 115 may refrain from blind decoding, or may perform less blind decoding to monitor for and receive communications via the shared channel 310 than via the control channel 305. A time duration 340 as described herein may represent a slot, one or more symbols, a TTI, or some other duration of time (e.g., time resources). In some examples, the time duration 340 may be a granularity for scheduling communications via the shared channel 310.

The network entity 105 may transmit a first DCI 320 via the control channel 305 in a first monitoring occasion 315-a. The first DCI 320 may be a scheduling DCI, and may represent an example of the scheduling DCI 220 described with reference to FIG. 2. The first DCI 320 may, for example, include a first scheduling indication 345-a that schedules communications in or otherwise points to a first time duration 340 on the shared channel 310, and may include a second scheduling indication 345-b that schedules a DCI 320-a via one or more time and frequency resources within the shared channel 310 during the first time duration 340 (e.g., the scheduling indication 345-b may indicate DCI piggybacking on PDSCH).

In some examples (not pictured in FIG. 3), the network entity 105 may transmit an RRC message that configures various communication parameters for the UE 115 and that indicates a control channel skipping configuration 325 (e.g., a PDCCH skipping order). The control channel skipping configuration 325 may thereby indicate that the UE 115 is to skip monitoring other monitoring occasions 315 (e.g., the monitoring occasions 315-b, 315-c, and 315-d) in the control channel 305 that at least partially overlap in time with time durations 340 during which a subsequent scheduling DCI 320 schedules DCI piggybacking on the shared channel 310. In some examples, the RRC message may indicate a duration for skipping control channel monitoring, or the network entity 105 may transmit a second RRC message at a second time to indicate an end to the control channel 305 skipping.

Additionally, or alternatively, the network entity 105 may transmit the control channel skipping configuration 325 via the scheduling DCI 320 in the first monitoring occasion 315-a on the control channel 305. That is, the UE 115 may monitor the control channel 305 during the first monitoring occasion 315-a, and may receive the scheduling DCI 320 including both the control channel skipping configuration 325 and scheduling information, such as the scheduling indications 345-a and 345-b, that schedule DCI piggybacking on the shared channel 310 in one or more subsequent time durations 340. Since the UE 115 is expected to skip monitoring the control channel 305 until the UE 115 receives some stoppage indication or a skipping duration has expired, the network entity 105 may not signal a stoppage of the skip order via another DCI on the control channel 305 (as the UE 115 may not monitor the control channel 305). As such, in some examples, the control channel skipping configuration 325 conveyed via the scheduling DCI 320 may signal a skipping duration (e.g., a quantity of time durations 340, or other unit of time for which the UE 115 is to skip monitoring the control channel 305). However, signaling of the skipping duration via the scheduling DCI 320 may increase overhead and may not be supported by one or more types of DCI formats.

Accordingly, the techniques described herein provide for the DCIs 320 that are piggybacked on the shared channel 310 to convey one or more indications of when the UE 115 is to stop skipping control channel monitoring. In some examples, a first DCI 320 that is piggybacked on the shared channel 310 after the scheduling DCI 320 may signal a skip duration 335, and later piggybacked DCIs 320 may not signal the duration. For example, the scheduling DCI 320 in the monitoring occasion 315-f may schedule the first DCI 320-d in a second sequence of piggybacked DCIs 320 on the shared channel 310. The DCI 320-d may include one or more bits or fields configured to indicate the skip duration 335, which may be a quantity of time durations 340 or other unit of time for which the UE 115 is to continue skipping monitoring the control channel 305. In the example of FIG. 3, the DCI 320-d may indicate a skip duration 335 of three time durations 340. As such, the UE 115 may skip monitoring the control channel 305 during the next three monitoring occasions 315-g, 315-h, and 315-i, that overlap with the next three time durations 340 after the skip duration 335 is conveyed. The UE 115 may resume monitoring the control channel 305 in the monitoring occasion 315-j after the skip duration 335 has expired.

Additionally, or alternatively, each DCI 320 that is piggybacked on the shared channel 310 may signal whether the UE 115 should skip a next (e.g., subsequent, consecutive) monitoring occasion 315 on the control channel 305 that overlaps at least partially in time with a next DCI 320 on the shared channel 310. Each DCI 320 on the shared channel 310 may include a scheduling indication 345 that points to or otherwise schedules or indicates whether a next time duration 340 on the shared channel 310 will include another piggybacked DCI 320 or not. Thus, each DCI 320 may additionally convey a conditional skip indication 330 that indicates whether the UE 115 is to continue PDCCH skipping in the next time duration 340 or not. The condition skip indication 330 may be a new single-bit or multi-bit indication conveyed via each piggybacked DCI 320. For example, if the conditional skip indication 330 has a first value (e.g., a bit “1”), this may indicate that the UE 115 is to skip monitoring a next monitoring occasion 315 on the control channel 305. If the conditional skip indication 330 has a second value (e.g., a bit “0”), this may indicate that the UE 115 is to stop the skipping and is to monitor the next monitoring occasion 315 on the control channel 305.

With reference to FIG. 3, for example, the DCI 320-d may include a first scheduling indication 345-c that indicates or otherwise schedules a next time duration 340 on the shared channel 310, as well as a second scheduling indication 345-d that indicates the DCI 320-e will be conveyed via the shared channel 310 in the next time duration 340. The DCI 320-d may further include a conditional skip indication 330, which may indicate that the UE 115 is to continue skipping PDCCH monitoring in the next time duration 340. The UE 115 may thereby refrain from monitoring the control channel 305 during the monitoring occasion 315-g based on the condition skip indication 330 conveyed via the DCI 320-d. The next DCI 320-e may include another conditional skip indication 330, which may indicate that the UE 115 is to continue to refrain from monitoring the control channel 305 during the next time duration 340 because the DCI 320-f may be scheduled in the next time duration 340. The DCI 320-f may include another conditional skip indication 330. In this example, the DCI 320-fmay not schedule a next DCI 320 in the shared channel 310. That is, the DCI 320-f may end the DCI piggyback chain. However, the DCI 320-f may still indicate, via the conditional skip indication 330, that the UE 115 is to refrain from monitoring the control channel 305 for one more time duration 340 before resuming control channel monitoring. The UE 115 may thereby refrain from monitoring the control channel 305 during the monitoring occasion 315-i and may resume monitoring the control channel 305 during the monitoring occasion 315-j. Although not illustrated, in some examples, the DCI 320-f may alternatively indicate, via the condition skip indication 330, that the next monitoring occasion 315-i on the control channel 305 is not to be skipped, and the UE 115 may monitor the control channel 305 during the monitoring occasion 315-iaccordingly.

Although described with reference to the chain of piggybacked DCIs 320-d, 320-e, and 320-f, it is to be understood that the conditional skip indications 330 may be conveyed via any of the DCIs 320 illustrated in FIG. 3. For example, the chain including the DCIs 320-a, 320-b, and 320-c may each convey a respective conditional skip indication 330 that indicates whether the UE 115 is to skip monitoring the control channel 305 in a next monitoring occasion 315. Additionally, or alternatively, the DCI 320-a may indicate a skip duration 335 over which the UE 115 is to perform PDCCH skipping before resuming monitoring of the control channel 305 in the monitoring occasion 315-e. For example, the skip duration 335 conveyed via the DCI 320-a may indicate a duration of three time durations 340, such that the UE 115 may refrain from monitoring the control channel 305 during each of the three monitoring occasions 315-b, 315-c, and 315-d.

The control channel 305 may convey broadcast control information, unicast control information, multicast control information, or any combination thereof. For example, different monitoring occasions 315 on the control channel 305 may be included in different search space sets, including group common search space sets, UE-specific search space sets, or both. In some examples, both UE-specific and group-common search space sets and monitoring occasions 315 included therein may overlap at least partially in time with one or more time durations 340 in which DCI 320 is piggybacked on the shared channel 310. As described herein, the UE 115 may either skip monitoring occasions 315 in both the unicast and broadcast search space sets, or the UE 115 may only skip monitoring the control channel 305 during monitoring occasions in the unicast search space set, but may still monitor the monitoring occasions 315 in the broadcast search space set.

The indication of whether the control channel skipping applies to both unicast control channel monitoring and broadcast control channel monitoring or to only one of unicast control channel monitoring or broadcast control channel monitoring may be conveyed to the UE 115 via control signaling, via the control channel skipping configuration 325, may be defined in a standard, or any combination thereof. In some examples, if both broadcast and unicast PDCCHs overlap with DCI 320 piggybacked on the PDSCH, the UE 115 may skip monitoring both of the unicast and broadcast PDCCHs that overlap, at least partially, with the DCI 320 piggybacked on the PDSCH. Additionally, or alternatively, if both broadcast and unicast PDCCHs overlap with DCI 320 piggybacked on the PDSCH, the UE 115 may skip monitoring the unicast PDCCHs that overlap, at least partially, with the DCI 320 piggybacked on the PDSCH, but the UE 115 may not skip monitoring the broadcast PDCCHs that overlap, at least partially, with the DCI 320 piggybacked on the PDSCH.

Accordingly, the techniques described herein provide for a network entity 105 to indicate a control channel skipping configuration 325 to a UE 115 via RRC signaling, scheduling DCI 320, or both. The control channel skipping configuration 325 may enable the UE 115 to skip control channel monitoring during monitoring occasions 315 on the control channel 305 that overlap, at least partially, in time with time durations 340 in which DCI 320 is scheduled for transmission via the shared channel 310. The combined control channel skipping and DCI piggybacking techniques described herein may improve coordination between devices, improve throughput, and reduce overhead and processing, among other examples.

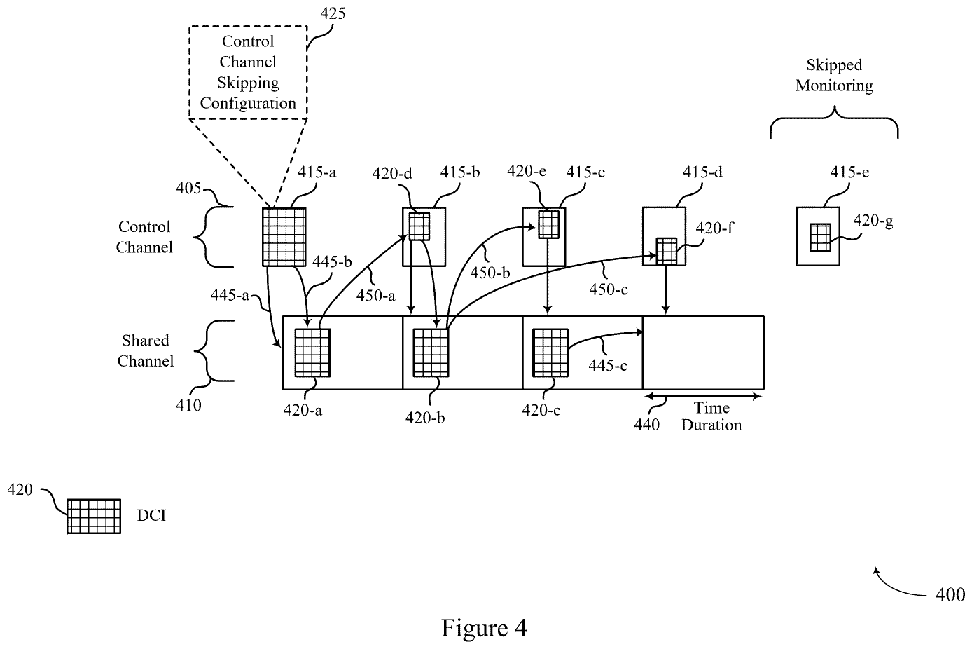

FIG. 4 shows an example of a communication timeline 400 that supports control channel skipping during overlapping control information piggyback durations. The communication timeline 400 may implement or be implemented by aspects of the wireless communication system 100 and the signaling configuration 200, as described with reference to FIGS. 1 and 2. For example, the communication timeline 400 illustrates a timeline for communications between a UE 115 and a network entity, which may represent examples of corresponding devices as described with reference to FIGS. 1 and 2. The UE 115 and the network entity 105 may communicate via a control channel 405 and a shared channel 410, which may represent examples of the control channel 205 and the shared channel 210, respectively, as described with reference to FIG. 2. As described herein, the network entity 105 may transmit one or more messages or other indications to the UE 115 to enable the UE 115 to skip monitoring the control channel 405 during at least a portion of one or more monitoring occasions 415.

The control channel 405 may be a PDCCH or other type of control channel that includes multiple monitoring occasions 415 (e.g., monitoring occasions 415-a, 415-b, 415-c, 415-d, and 415-e). A monitoring occasion 415 may include one or more time and frequency resources within the control channel 405 that are allocated for potential control signaling targeting the UE 115. The UE 115 may receive control signaling that indicates the monitoring occasions 415 and/or a periodicity of the monitoring occasions 415, and the UE 115 may monitor the control channel using blind decoding techniques during the monitoring occasions 415.

The shared channel 410 may be a PDSCH or other type of shared channel that includes one or more time durations 440. Communications via the shared channel 410 may be scheduled via a scheduling DCI conveyed via the control channel 405, via piggybacked DCI 420 conveyed via the shared channel 410, or both. Accordingly, the UE 115 may refrain from blind decoding, or may perform less blind decoding to monitor for and receive communications via the shared channel 410 than via the control channel 405. A time duration 440 as described herein may represent a slot, one or more symbols, a TTI, or some other duration of time (e.g., time resources). In some examples, the time duration 440 may be a granularity for scheduling communications via the shared channel 410.

The network entity 105 may transmit a first DCI 420 via the control channel 405 in a first monitoring occasion 415-a. The first DCI 420 may be a scheduling DCI, and may represent an example of the scheduling DCI 220 described with reference to FIG. 2. The first DCI 420 may, for example, include a first scheduling indication 445-a that schedules communications in or otherwise points to a first time duration 440 on the shared channel 410, and may include a second scheduling indication 445-b that schedules a DCI 420-a via one or more time and frequency resources within the shared channel 410 during the first time duration 440 (e.g., the scheduling indication 445-b may indicate DCI piggybacking on PDSCH).

In some examples (not pictured in FIG. 4), the network entity 105 may transmit an RRC message that configures various communication parameters for the UE 115 and that indicates a control channel skipping configuration 425 (e.g., a PDCCH skipping order). The control channel skipping configuration 425 may thereby indicate that the UE 115 is to skip monitoring other monitoring occasions 415 (e.g., the monitoring occasions 415-b, 415-c, and 415-d) in the control channel 405 that at least partially overlap in time with time durations 440 during which a subsequent scheduling DCI 420 schedules DCI piggybacking on the shared channel 410. In some examples, the RRC message may indicate a duration for skipping control channel monitoring, or the network entity 105 may transmit a second RRC message at a second time to indicate an end to the control channel 405 skipping.

Additionally, or alternatively, the network entity 105 may transmit the control channel skipping configuration 425 via the scheduling DCI 420 in the first monitoring occasion 415-a on the control channel 405. That is, the UE 115 may monitor the control channel 405 during the first monitoring occasion 415-a, and may receive the scheduling DCI 420 including both the control channel skipping configuration 425 and scheduling information, such as the scheduling indications 445-a and 445-b, that schedule DCI piggybacking on the shared channel 410 in one or more subsequent time durations 440.

In some examples, the DCIs 420-a, 420-b, and 420-c that are piggybacked on the shared channel 410 may be referred to as or may otherwise include one or more DCI indicators (DCIIs). A DCII may be used as or may include one or more pointers 450 to a location of DCI 420 on the control channel 405. Such pointers 450 may reduce a size of the piggyback DCIs 420, but may increase blind detection on the control channel 405 as compared with systems in which the control information is conveyed via the shared channel 410. The pointers 450 may indicate time and frequency resources (e.g., one or more control channel elements (CCEs)) within a monitoring occasion 415 on the control channel 405 that are allocated for a DCI 420. The DCII may include control information that is not related to DCI allocation, and may indicate information to assist with detection of other DCIs 420. In some examples, the DCII and pointers 450 may indicate a starting CCE of a corresponding DCI 420, which may provide for a trade-off between reduced DCII size and increased quantity of blind decodes used for detection of the DCI 420. In some examples, the pointers 450 may indicate a CORESET ID for the corresponding DCI 420 if there are multiple CORESET options, for example.

As described herein, when the UE 115 receives a DCII that indicates a candidate DCI 420, the UE 115 may skip monitoring the control channel 405 (e.g., CORESETS in the PDCCH) for any DCIs 420 or control information other than the DCI 420 indicated via the DCII. For example, in FIG. 4, the DCI 420-a may include the pointer 450-a that points to a portion of the monitoring occasion 415-b via which a DCI 420-d may be conveyed. If the UE 115 previously received the control channel skipping configuration 425 and is enabled to skip control channel monitoring in monitoring occasions 415 that overlap with piggybacked DCI 420, the pointer 450 conveyed via DCII may override the control channel skipping configuration 425, such that the UE 115 may refrain from monitoring all of the monitoring occasion 415-b, but the UE 115 may monitor the portion of the monitoring occasion 415-b indicated via the pointer 450-a. The UE 115 may thereby receive the DCI 420-d on the control channel 405 before returning to PDCCH skipping.

In the example of FIG. 4, the DCI 420-b may additionally include two pointers 450-b and 450-c, which may point to portions of the monitoring occasions 415-c and 415-d, respectively, on the control channel 405, that may include the DCIs 420-e and 420-f. The UE 115 may thereby monitor the portions of the monitoring occasions 415-c and 415-d and receive the DCIs 420-d and 420-b based on the pointers 450-b and 450-c. The UE 115 may refrain from monitoring any other portion of the control channel 405 during these durations in accordance with the control channel skipping configuration 425.

If a DCI 420 is not indicated by DCII piggybacked on the shared channel 410, the UE 115 may refrain from monitoring for the DCI 420 based on the control channel skipping configuration 425. For example, the DCI 420-g in the monitoring occasion 415-e may not be indicated by any DCI 420 on the shared channel (e.g., the DCI 420-c may not include any pointers 450 but may instead include a scheduling indication 445-c that points to a next time duration 440 on the shared channel 410). As such, the UE 115 may skip monitoring the control channel 405 during the monitoring occasion 415-e if the skip duration conveyed via the control channel skipping configuration, via one or more of the DCIs 420, or both, has not yet expired.

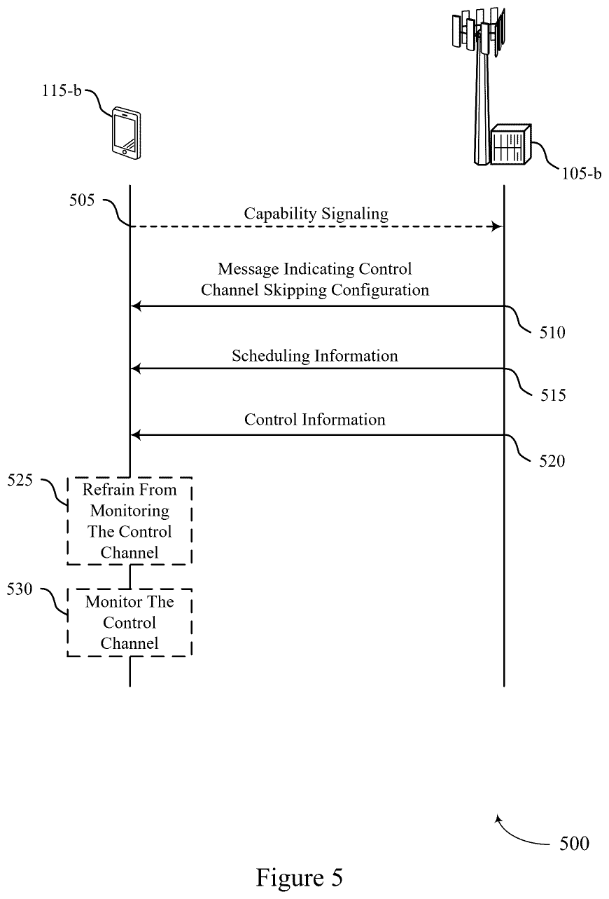

FIG. 5 shows an example of a process flow 500 that supports control channel skipping during overlapping control information piggyback durations. The process flow 500 may implement or may be implemented by aspects of FIGS. 1 through 4. For example, the process flow 500 illustrates communications between a UE 115-b and a network entity 105-b, which may represent examples of corresponding devices as described with reference to FIGS. 1 through 4. In this example, the network entity 105-b may enable the UE 115-b to perform control channel skipping during durations in which the UE 115-b is to receive DCI piggybacked on a shared channel.

In the following description of the process flow 500, the operations between the devices may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may occur at the same time.

At 505, in some examples, the UE 115-b may transmit capability signaling to the network entity 105-b. The capability signaling may indicate a capability of the UE 115-b to receive a control channel skipping configuration via a scheduling DCI message. That is, the UE 115-b may indicate whether the UE 115-b supports the indication of PDCCH skipping by scheduling DCI (e.g., the DCI that enables DCI piggyback on PDSCH) if DCI piggyback on PDSCH is configured.

At 510, the network entity 105-b may transmit a message to the UE 115-a to indicate the control channel skipping configuration for the UE 115-b. The control channel skipping configuration may enable the UE 115-b to skip control channel monitoring during one or more monitoring occasions that at least partially overlap in time with one or more time durations in which control information is conveyed via a shared channel that is different from a control channel associated with the one or more monitoring occasions. In some examples, the message may be an RRC message that indicate the control channel skipping configuration and that enables the UE 115-b to skip the control channel monitoring during the one or more monitoring occasions that at least partially overlap with the one or more time durations.

Additionally, or alternatively, the message may be a scheduling DCI message that indicates the control channel skipping configuration and that includes information that schedules transmission of the control information via the shared channel during the one or more time durations. In some examples, the control channel skipping configuration may be indicated via the scheduling DCI based on the UE 115-b indicating, via the capability signaling at 505, that the UE 115-b is capable of receiving such a control channel skipping configuration via a scheduling DCI.

At 515, the network entity 105-b may transmit, to the UE 115-b via the control channel, information that schedules the transmission of the control information via the shared channel during the one or more time durations. If the message that indicates the control channel skipping configuration at 510 is an RRC message, the network entity 105-b may subsequently convey the scheduling information at 515 via a scheduling DCI on the control channel. If the message that indicates the control channel skipping configuration at 510 is the scheduling DCI, the network entity 105-b may also convey the scheduling information via the same scheduling DCI. In such cases, the network entity 105-b may transmit the message and the scheduling information at 510 and 515 via a same message. The UE 115-b may monitor a monitoring occasion on the control channel and may receive, in accordance with the monitoring (e.g., and blind decoding), the scheduling information. The scheduling information may indicate that DCI piggybacking is activated in one or more subsequent time durations on the shared channel.

At 520, the network entity 105-b may transmit, to the UE 115-b, the control information via the shared channel during the one or more time durations. The network entity 105-b may, for example, transmit the control information via one or more DCI messages piggybacked on the shared channel in accordance with the scheduling information and the control channel skipping configuration. The UE 115-b may receive the control information via the shared channel during the one or more time durations according to the scheduling information and the control channel skipping configuration.

At 525, in some examples, the UE 115-b may refrain from monitoring the control channel during the one or more monitoring occasions in accordance with the control channel skipping configuration and the scheduling information enabling the DCI piggybacking. For example, the UE 115-b may refrain from monitoring the control channel during monitoring occasions that at least partially overlap in time with the time durations during which control information is conveyed via the shared channel. In some examples, refraining from monitoring the control channel may be referred to as performing control channel skipping.

At 530, in some examples, the UE 115-b may monitor the control channel. For example, the UE 115-b may monitor the control channel during one or more second monitoring occasions in accordance with a duration indicated via the control channel skipping configuration expiring before the one or more second monitoring occasions. Additionally, or alternatively, the UE 115-b may monitor the control channel if the UE 115-b identifies that there is no control information scheduled for transmission via the shared channel during the one or more second monitoring occasions.

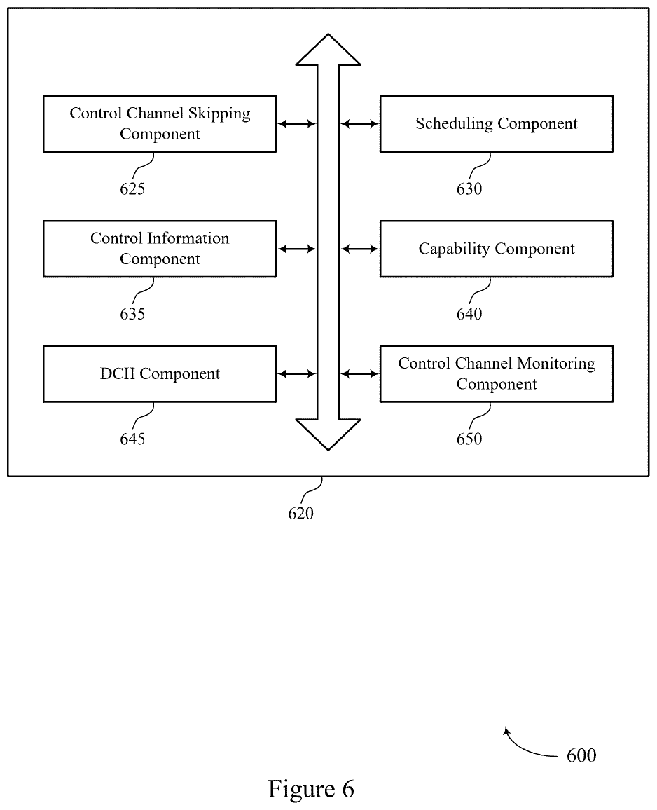

FIG. 6 shows an example 600 of a processing system 620 that supports control channel skipping during overlapping control information piggyback durations. A processing system 620 may be an example of a processing system 140 (such as of a UE 115) and may include a control channel skipping component 625, a scheduling component 630, a control information component 635, a capability component 640, a DCII component 645, a control channel monitoring component 650, or any combination thereof. A processing system 620, or various component thereof, may be an example of means for performing (such as a means for causing a UE 115 to perform) various techniques described herein.

Additionally, or alternatively, the control channel skipping component 625 may be configured to cause the UE 115 to receive a message that indicates a control channel skipping configuration for the UE, where the control channel skipping configuration enables the UE to skip control channel monitoring during one or more monitoring occasions which at least partially overlap with one or more time durations in which control information is conveyed via a shared channel that is different from a control channel associated with the one or more monitoring occasions. The scheduling component 630 may be configured to cause the UE 115 to receive, via the control channel, information that schedules transmission of the control information via the shared channel during the one or more time durations. The control information component 635 may be configured to cause the UE 115 to receive, via the shared channel, the control information during the one or more time durations in accordance with the information and the control channel skipping configuration.

In some examples, to support receiving the message, the control channel skipping component 625 may be configured to cause the UE 115 to receive a RRC message that indicates the control channel skipping configuration and enables the UE to skip the control channel monitoring during the one or more monitoring occasions which at least partially overlap with the one or more time durations in which the control information is conveyed via the shared channel.

In some examples, the control channel skipping component 625 may be configured to cause the UE 115 to receive, at a time that is after the one or more time durations, a second RRC message that indicates an end to the control channel skipping configuration.

In some examples, to support receiving the message and the information, the control channel skipping component 625 may be configured to cause the UE 115 to receive, via a first monitoring occasion on the control channel, a DCI message, where the DCI message indicates the control channel skipping configuration and includes the information that schedules the transmission of the control information via the shared channel during the one or more time durations.

In some examples, the capability component 640 may be configured to cause the UE 115 to transmit capability signaling that indicates a capability of the UE to receive the control channel skipping configuration via a scheduling DCI message, where the scheduling DCI message is received via a first monitoring occasion on the control channel based on the capability signaling, and where the scheduling DCI message indicates the control channel skipping configuration and includes the information that schedules the transmission of the control information via the shared channel during the one or more time durations based on the capability signaling.

In some examples, the information indicates a duration over which the UE is to skip the control channel monitoring in accordance with the control channel skipping configuration.

In some examples, to support receiving the control information, the control information component 635 may be configured to cause the UE 115 to receive, via the shared channel, a set of multiple instances of the control information during the one or more time durations, where a first instance of the set of multiple instances is received during a first time duration and indicates a duration over which the UE is to skip the control channel monitoring in accordance with the control channel skipping configuration.

In some examples, to support receiving the control information, the control information component 635 may be configured to cause the UE 115 to receive, via the shared channel, a set of multiple instances of the control information during the one or more time durations, where each instance of the set of multiple instances is received during a respective time duration and includes a conditional skip indication that indicates whether the UE is to continue to skip the control channel monitoring during a next monitoring occasion that is after the respective time duration during.

In some examples, the message indicates that the control channel skipping configuration applies to both unicast control channel monitoring and broadcast control channel monitoring.

In some examples, the message indicates that the control channel skipping configuration applies to one of unicast control channel monitoring or broadcast control channel monitoring.

In some examples, to support receiving the control information, the DCII component 645 may be configured to cause the UE 115 to receive, via a first time duration of the one or more time durations and via the shared channel, the control information including a DCII that points to a DCI message scheduled in a portion of a next monitoring occasion that is after the first time duration, where the next monitoring occasion is one of the one or more monitoring occasions that at least partially overlap with the one or more time durations in which the control information is conveyed, and where the control channel skipping configuration enables the UE to skip the control channel monitoring during the one or more monitoring occasions except the portion of the next monitoring occasion in which the DCI message is scheduled.

In some examples, the DCII component 645 may be configured to cause the UE 115 to monitor the control channel during the portion of the next monitoring occasion in accordance with the DCII. In some examples, the DCII component 645 may be configured to cause the UE 115 to receive the DCI message based on the monitoring.

In some examples, the control channel skipping component 625 may be configured to cause the UE 115 to refrain, in accordance with the control channel skipping configuration, from monitoring the control channel during the one or more monitoring occasions.

In some examples, the control channel monitoring component 650 may be configured to cause the UE 115 to monitor the control channel during one or more second monitoring occasions in accordance with a duration of the control channel skipping configuration expiring before the one or more second monitoring occasions.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for improved communication reliability, improved user experience related to reduced processing, reduced power consumption, more efficient utilization of communication resources, and improved coordination between devices, among other examples.

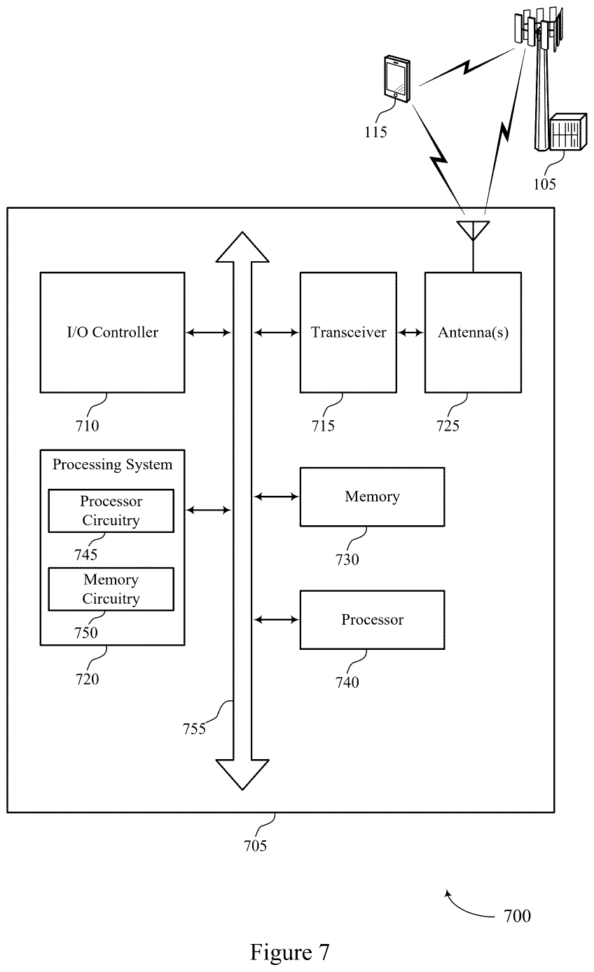

FIG. 7 shows an example of a system 700 including a device 705 that supports control channel skipping during overlapping control information piggyback durations. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support control channel skipping during overlapping control information piggyback durations. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, improved user experience related to reduced processing, reduced power consumption, more efficient utilization of communication resources, improved coordination between devices, and longer battery life, among other examples.

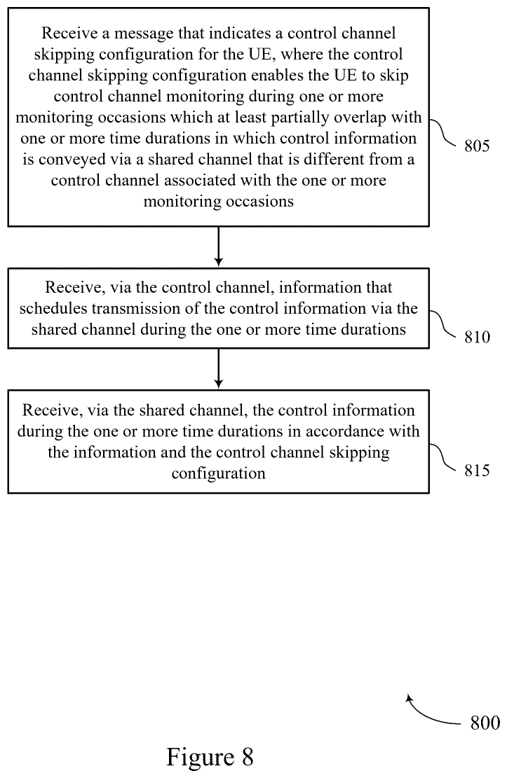

FIG. 8 shows an example of a method 800 that supports control channel skipping during overlapping control information piggyback durations. Operations of the method 800 may be performed by a UE or its components (such as using a processing system configured to cause the UE 115 to perform one or more of the operations) as described herein.

At 805, the method may include receiving a message that indicates a control channel skipping configuration for the UE, where the control channel skipping configuration enables the UE to skip control channel monitoring during one or more monitoring occasions which at least partially overlap with one or more time durations in which control information is conveyed via a shared channel that is different from a control channel associated with the one or more monitoring occasions. In some examples, aspects of the operations of 805 may be performed by a control channel skipping component 625.

At 810, the method may include receiving, via the control channel, information that schedules transmission of the control information via the shared channel during the one or more time durations. In some examples, aspects of the operations of 810 may be performed by a scheduling component 630.

At 815, the method may include receiving, via the shared channel, the control information during the one or more time durations in accordance with the information and the control channel skipping configuration. In some examples, aspects of the operations of 815 may be performed by a control information component 635.

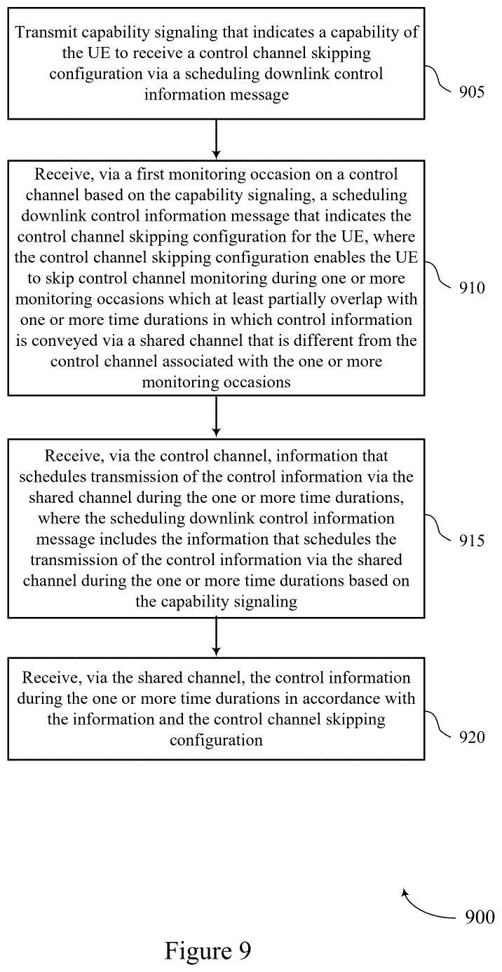

FIG. 9 shows an example of a method 900 that supports control channel skipping during overlapping control information piggyback durations. Operations of the method 900 may be performed by a UE or its components (such as using a processing system configured to cause the UE 115 to perform one or more of the operations) as described herein.

At 905, the method may include transmitting capability signaling that indicates a capability of the UE to receive the control channel skipping configuration via a scheduling DCI message, where the scheduling DCI message is received via a first monitoring occasion on the control channel based on the capability signaling, and where the scheduling DCI message indicates the control channel skipping configuration and includes the information that schedules the transmission of the control information via the shared channel during the one or more time durations based on the capability signaling. In some examples, aspects of the operations of 905 may be performed by a capability component 640.

At 910, the method may include receiving a message that indicates a control channel skipping configuration for the UE, where the control channel skipping configuration enables the UE to skip control channel monitoring during one or more monitoring occasions which at least partially overlap with one or more time durations in which control information is conveyed via a shared channel that is different from a control channel associated with the one or more monitoring occasions. In some examples, aspects of the operations of 910 may be performed by a control channel skipping component 625.

At 915, the method may include receiving, via the control channel, information that schedules transmission of the control information via the shared channel during the one or more time durations. In some examples, aspects of the operations of 915 may be performed by a scheduling component 630.

At 920, the method may include receiving, via the shared channel, the control information during the one or more time durations in accordance with the information and the control channel skipping configuration. In some examples, aspects of the operations of 920 may be performed by a control information component 635.

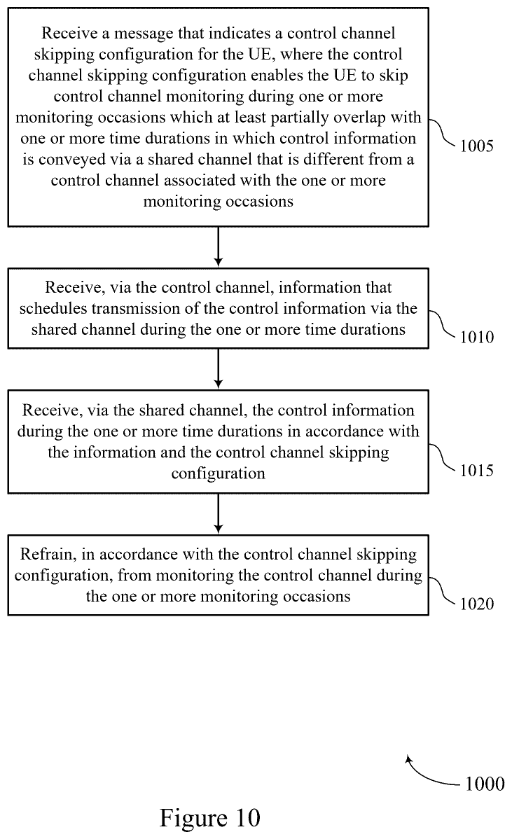

FIG. 10 shows an example of a method 1000 that supports control channel skipping during overlapping control information piggyback durations. Operations of the method 1000 may be performed by a UE or its components (such as using a processing system configured to cause the UE 115 to perform one or more of the operations) as described herein.

At 1005, the method may include receiving a message that indicates a control channel skipping configuration for the UE, where the control channel skipping configuration enables the UE to skip control channel monitoring during one or more monitoring occasions which at least partially overlap with one or more time durations in which control information is conveyed via a shared channel that is different from a control channel associated with the one or more monitoring occasions. In some examples, aspects of the operations of 1005 may be performed by a control channel skipping component 625.

At 1010, the method may include receiving, via the control channel, information that schedules transmission of the control information via the shared channel during the one or more time durations. In some examples, aspects of the operations of 1010 may be performed by a scheduling component 630.

At 1015, the method may include receiving, via the shared channel, the control information during the one or more time durations in accordance with the information and the control channel skipping configuration. In some examples, aspects of the operations of 1015 may be performed by a control information component 635.

At 1020, the method may include refraining, in accordance with the control channel skipping configuration, from monitoring the control channel during the one or more monitoring occasions. In some examples, aspects of the operations of 1020 may be performed by a control channel skipping component 625.

Implementation examples are described in the following numbered clauses:

Aspect 1: A method for wireless communication by a UE, comprising: receiving a message that indicates a control channel skipping configuration for the UE, wherein the control channel skipping configuration enables the UE to skip control channel monitoring during one or more monitoring occasions which at least partially overlap with one or more time durations in which control information is conveyed via a shared channel that is different from a control channel associated with the one or more monitoring occasions; receiving, via the control channel, information that schedules transmission of the control information via the shared channel during the one or more time durations; and receiving, via the shared channel, the control information during the one or more time durations in accordance with the information and the control channel skipping configuration.

Aspect 2: The method of aspect 1, wherein receiving the message comprises: receiving a RRC message that indicates the control channel skipping configuration and enables the UE to skip the control channel monitoring during the one or more monitoring occasions which at least partially overlap with the one or more time durations in which the control information is conveyed via the shared channel.

Aspect 3: The method of aspect 2, further comprising: receiving, at a time that is after the one or more time durations, a second RRC message that indicates an end to the control channel skipping configuration.

Aspect 4: The method of aspect 1, wherein receiving the message and the information comprises: receiving, via a first monitoring occasion on the control channel, a DCI message, wherein the DCI message indicates the control channel skipping configuration and includes the information that schedules the transmission of the control information via the shared channel during the one or more time durations.

Aspect 5: The method of any of aspects 1 through 4, further comprising: transmitting capability signaling that indicates a capability of the UE to receive the control channel skipping configuration via a scheduling DCI message, wherein the scheduling DCI message is received via a first monitoring occasion on the control channel based at least in part on the capability signaling, and wherein the scheduling DCI message indicates the control channel skipping configuration and includes the information that schedules the transmission of the control information via the shared channel during the one or more time durations based at least in part on the capability signaling.

Aspect 6: The method of any of aspects 1 through 5, wherein the information indicates a duration over which the UE is to skip the control channel monitoring in accordance with the control channel skipping configuration.

Aspect 7: The method of any of aspects 1 through 6, wherein receiving the control information comprises: receiving, via the shared channel, a plurality of instances of the control information during the one or more time durations, wherein a first instance of the plurality of instances is received during a first time duration and indicates a duration over which the UE is to skip the control channel monitoring in accordance with the control channel skipping configuration.

Aspect 8: The method of any of aspects 1 through 6, wherein receiving the control information comprises: receiving, via the shared channel, a plurality of instances of the control information during the one or more time durations, wherein each instance of the plurality of instances is received during a respective time duration and comprises a conditional skip indication that indicates whether the UE is to continue to skip the control channel monitoring during a next monitoring occasion that is after the respective time duration during.

Aspect 9: The method of any of aspects 1 through 8, wherein the message indicates that the control channel skipping configuration applies to both unicast control channel monitoring and broadcast control channel monitoring.

Aspect 10: The method of any of aspects 1 through 8, wherein the message indicates that the control channel skipping configuration applies to one of unicast control channel monitoring or broadcast control channel monitoring.

Aspect 11: The method of any of aspects 1 through 10, wherein receiving the control information comprises: receiving, via a first time duration of the one or more time durations and via the shared channel, the control information comprising a DCII that points to a DCI message scheduled in a portion of a next monitoring occasion that is after the first time duration, wherein the next monitoring occasion is one of the one or more monitoring occasions that at least partially overlap with the one or more time durations in which the control information is conveyed, and wherein the control channel skipping configuration enables the UE to skip the control channel monitoring during the one or more monitoring occasions except the portion of the next monitoring occasion in which the DCI message is scheduled.

Aspect 12: The method of aspect 11, further comprising: monitoring the control channel during the portion of the next monitoring occasion in accordance with the DCII; and receiving the DCI message based at least in part on the monitoring.

Aspect 13: The method of any of aspects 1 through 12, further comprising: refraining, in accordance with the control channel skipping configuration, from monitoring the control channel during the one or more monitoring occasions.

Aspect 14: The method of any of aspects 1 through 12, further comprising: monitoring the control channel during one or more second monitoring occasions in accordance with a duration of the control channel skipping configuration expiring before the one or more second monitoring occasions.

Aspect 15: A UE for wireless communication, comprising a processing system that includes processor circuitry and memory circuitry that stores code, the processing system configured to cause the UE to perform a method of any of aspects 1 through 14.

Aspect 16: A UE for wireless communication, comprising at least one means for performing a method of any of aspects 1 through 14.

Aspect 17: A non-transitory computer-readable medium storing code for wireless communication, the code comprising instructions executable by one or more processors to perform a method of any of aspects 1 through 14.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a message that indicates a control channel skipping configuration for the UE, wherein the control channel skipping configuration enables the UE to skip control channel monitoring during one or more monitoring occasions which at least partially overlap with one or more time durations in which control information is conveyed via a shared channel that is different from a control channel associated with the one or more monitoring occasions;
receive, via the control channel, information that schedules transmission of the control information via the shared channel during the one or more time durations; and
receive, via the shared channel, the control information during the one or more time durations in accordance with the information and the control channel skipping configuration.

2. The UE of claim 1, wherein, to receive the message, the processing system is configured to cause the UE to:
receive a radio resource control message that indicates the control channel skipping configuration and enables the UE to skip the control channel monitoring during the one or more monitoring occasions which at least partially overlap with the one or more time durations in which the control information is conveyed via the shared channel.

3. The UE of claim 2, wherein the processing system is further configured to cause the UE to:
receive, at a time that is after the one or more time durations, a second radio resource control message that indicates an end to the control channel skipping configuration.

4. The UE of claim 1, wherein, to receive the message and the information, the processing system is configured to cause the UE to:
receive, via a first monitoring occasion on the control channel, a downlink control information message, wherein the downlink control information message indicates the control channel skipping configuration and includes the information that schedules the transmission of the control information via the shared channel during the one or more time durations.

5. The UE of claim 1, wherein the processing system is further configured to cause the UE to:
transmit capability signaling that indicates a capability of the UE to receive the control channel skipping configuration via a scheduling downlink control information message, wherein the scheduling downlink control information message is received via a first monitoring occasion on the control channel based at least in part on the capability signaling, and wherein the scheduling downlink control information message indicates the control channel skipping configuration and includes the information that schedules the transmission of the control information via the shared channel during the one or more time durations based at least in part on the capability signaling.

6. The UE of claim 1, wherein the information indicates a duration over which the UE is to skip the control channel monitoring in accordance with the control channel skipping configuration.

7. The UE of claim 1, wherein, to receive the control information, the processing system is configured to cause the UE to:
receive, via the shared channel, a plurality of instances of the control information during the one or more time durations, wherein a first instance of the plurality of instances is received during a first time duration and indicates a duration over which the UE is to skip the control channel monitoring in accordance with the control channel skipping configuration.

8. The UE of claim 1, wherein, to receive the control information, the processing system is configured to cause the UE to:
receive, via the shared channel, a plurality of instances of the control information during the one or more time durations, wherein each instance of the plurality of instances is received during a respective time duration and comprises a conditional skip indication that indicates whether the UE is to continue to skip the control channel monitoring during a next monitoring occasion that is after the respective time duration during.

9. The UE of claim 1, wherein the message indicates that the control channel skipping configuration applies to both unicast control channel monitoring and broadcast control channel monitoring.

10. The UE of claim 1, wherein the message indicates that the control channel skipping configuration applies to one of unicast control channel monitoring or broadcast control channel monitoring.

11. The UE of claim 1, wherein, to receive the control information, the processing system is configured to cause the UE to:
receive, via a first time duration of the one or more time durations and via the shared channel, the control information comprising a downlink control information indicator that points to a downlink control information message scheduled in a portion of a next monitoring occasion that is after the first time duration, wherein the next monitoring occasion is one of the one or more monitoring occasions that at least partially overlap with the one or more time durations in which the control information is conveyed, and wherein the control channel skipping configuration enables the UE to skip the control channel monitoring during the one or more monitoring occasions except the portion of the next monitoring occasion in which the downlink control information message is scheduled.

12. The UE of claim 11, wherein the processing system is further configured to cause the UE to:
monitor the control channel during the portion of the next monitoring occasion in accordance with the downlink control information indicator; and
receive the downlink control information message based at least in part on the monitoring.

13. The UE of claim 1, wherein the processing system is further configured to cause the UE to:
refrain, in accordance with the control channel skipping configuration, from monitoring the control channel during the one or more monitoring occasions.

14. The UE of claim 1, wherein the processing system is further configured to cause the UE to:
monitor the control channel during one or more second monitoring occasions in accordance with a duration of the control channel skipping configuration expiring before the one or more second monitoring occasions.

15. A method for wireless communication by a user equipment (UE), comprising:
receiving a message that indicates a control channel skipping configuration for the UE, wherein the control channel skipping configuration enables the UE to skip control channel monitoring during one or more monitoring occasions which at least partially overlap with one or more time durations in which control information is conveyed via a shared channel that is different from a control channel associated with the one or more monitoring occasions;
receiving, via the control channel, information that schedules transmission of the control information via the shared channel during the one or more time durations; and
receiving, via the shared channel, the control information during the one or more time durations in accordance with the information and the control channel skipping configuration.

16. The method of claim 15, wherein receiving the message comprises:
receiving a radio resource control message that indicates the control channel skipping configuration and enables the UE to skip the control channel monitoring during the one or more monitoring occasions which at least partially overlap with the one or more time durations in which the control information is conveyed via the shared channel.

17. The method of claim 15, wherein receiving the message and the information comprises:
receiving, via a first monitoring occasion on the control channel, a downlink control information message, wherein the downlink control information message indicates the control channel skipping configuration and includes the information that schedules the transmission of the control information via the shared channel during the one or more time durations.

18. The method of claim 15, further comprising:
transmitting capability signaling that indicates a capability of the UE to receive the control channel skipping configuration via a scheduling downlink control information message, wherein the scheduling downlink control information message is received via a first monitoring occasion on the control channel based at least in part on the capability signaling, and wherein the scheduling downlink control information message indicates the control channel skipping configuration and includes the information that schedules the transmission of the control information via the shared channel during the one or more time durations based at least in part on the capability signaling.

19. A non-transitory computer-readable medium storing code for wireless communication by a user equipment (UE), the code comprising instructions executable by one or more processors to:
receive a message that indicates a control channel skipping configuration for the UE, wherein the control channel skipping configuration enables the UE to skip control channel monitoring during one or more monitoring occasions which at least partially overlap with one or more time durations in which control information is conveyed via a shared channel that is different from a control channel associated with the one or more monitoring occasions;
receive, via the control channel, information that schedules transmission of the control information via the shared channel during the one or more time durations; and
receive, via the shared channel, the control information during the one or more time durations in accordance with the information and the control channel skipping configuration.

20. The non-transitory computer-readable medium of claim 19, wherein the instructions to receive the message are executable by the one or more processors to:
receive a radio resource control message that indicates the control channel skipping configuration and enables the UE to skip the control channel monitoring during the one or more monitoring occasions which at least partially overlap with the one or more time durations in which the control information is conveyed via the shared channel.
